(19) United States
(12) Patent Application Publication
(10) Pub. No.: US 2005/0115025 A1
(43) Pub. Date: Jun. 2, 2005

(54) Electronic apparatus having a rotatable display unit and hinge device used for the same

(75) Inventors: Hiroyuki Minaguchi, Higashimatsuyama-shi (JP); Hidemi Itakura, Nishitama-gun (JP); Takayuki Arisaka, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/994,528

(22) Filed: Nov. 23, 2004

(30) Foreign Application Priority Data
Nov. 28, 2003 (JP) 2003-400892

(51) Int. Cl. E05D 7/10

(52) U.S. Cl. 16/259

(57) ABSTRACT

An electronic apparatus includes a first housing, a second housing and a hinge device which rotatably connects the first housing with the second housing. The hinge device has a first bracket to be fixed to the first housing, a second bracket to be fixed to the second housing, and a hinge shaft which extends between the brackets. The first housing has a holding portion in a position corresponding to the first bracket. The holding portion catches the first bracket and thereby holds the hinge device accompanied with the second housing on the first housing.

### CROSS-REFERENCE TO RELATED APPLICATIONS

This application is based upon and claims the benefit of priority from prior Japanese Patent Application No. 2003-400892, filed Nov. 28, 2003, the entire contents of which are incorporated herein by reference.

### BACKGROUND OF THE INVENTION

1. Field of the Invention

This invention relates to an electronic apparatus, such as a portable computer, having a rotatable display unit. This invention also relates to a structure of a hinge device which rotatably supports a display unit.

2. Description of the Related Art

Portable computers, which are an example of an electronic apparatus, have a main unit having a keyboard and a display unit having a liquid crystal display. The display unit is rotatably supported by the main unit with a hinge device interposed therebetween.

The hinge device has a first bracket, a second bracket and a hinge shaft. An end of the hinge shaft is rotatably supported by the first bracket. The other end of the hinge shaft is fixed onto the second bracket. Therefore, the first bracket and the second bracket are relatively rotatable around the axis of the hinge shaft.

The main unit of portable computers has, for example, a base that supports a printed wiring board with a CPU, and a top cover covering the base. The display unit having an LCD cover that supports the liquid crystal display, and an LCD mask covering the LCD cover.

In conventional portable computers, the first bracket of the hinge device is fixed to an internal surface of the top cover by screws, and the second bracket is fixed to an internal surface of the LCD cover by screws. Therefore, in the step of assembling the portable computers, the top cover and the LCD cover are connected with the hinge device interposed therebetween to form an assembly. Japanese Patent No. 3382073 discloses such a portable computer.

According to the conventional portable computers, the hinge device is formed as one unitary piece with the top cover and the LCD cover. Therefore, the hinge device is a large-scale structure corresponding to the size of the portable computers. As a result, the hinge device obstructs assembling of the portable computer, and is a factor which deteriorates assembling workability of the portable computers.

To improve it, it is one choice to remove the first bracket of the hinge device from the top cover of the main unit to separate the top cover and the hinge device. Adopting this structure necessitates a step of fixing the first bracket of the hinge device to the base or top cover of the main unit by screws in assembling the portable computer.

Since the hinge device comes with the LCD cover, the heavy large LCD cover is located on the other side of the first bracket. Therefore, in temporarily fixing the first bracket onto the base or top cover, the hinge device may be inclined or fall down due to the weight of the LCD cover.

This makes temporal fixing of the first bracket difficult. Further, it is necessary to hold the LCD cover by hand in fixing the first bracket to the base or top cover by screws. This requires much time and labor in assembling of the portable computer, and cannot provide an effective measure to improve the workability.

### BRIEF SUMMARY OF THE INVENTION

According to an embodiment of the present invention, there is provided an electronic apparatus comprises: a first housing; a second housing separate from the first housing; and a hinge device which rotatably connects the first housing with the second housing. The hinge device includes a first bracket to be fixed to the first housing, a second bracket to be fixed to the second housing, and a hinge shaft which connects the first bracket and the second bracket such that the first and second brackets are relatively rotatable. The first housing has a holding portion in a position corresponding to the first bracket, and the holding portion catches the first bracket and thereby holds the hinge device accompanied with the second housing on the first housing.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a portable computer according to an embodiment of the present invention.

FIG. 2 is a perspective view of the portable computer according to the embodiment of the present invention, illustrating the state where a main unit and a display unit are separated.

FIG. 3 is a perspective view of a first hinge device according to the embodiment of the present invention.

FIG. 4 is a perspective view of a second hinge device according to the embodiment of the present invention.

FIG. 5 is a perspective view illustrating a positional relationship between the second hinge device fixed on an LCD cover and a base of the main unit in the embodiment of the present invention.

FIG. 6 is a perspective view illustrating a state where the first hinge device is fixed to the base of the main unit in the embodiment of the present invention.

FIG. 7 is a perspective view illustrating a state where the second hinge device is fixed to the base of the main unit in the embodiment of the present invention.

FIG. 8 is a plan view illustrating a state where the first hinge device is fixed to the base of the main unit in the embodiment of the present invention.

FIG. 9 is a cross-sectional view taken along a line F9-F9 in FIG. 8.

FIG. 10 is a cross-sectional view taken along a line F10-F10 in FIG. 8.

FIG. 11 is a perspective view illustrating a state where the first hinge device is temporarily fixed to the base of the main unit in the embodiment of the present invention.

FIG. 12 is a perspective view illustrating a state where the second hinge device is temporarily fixed to the base of the main unit in the embodiment of the present invention.

### DETAILED DESCRIPTION OF THE INVENTION

An embodiment of the present invention is explained on the basis of drawings in which the present invention is applied to a portable computer.

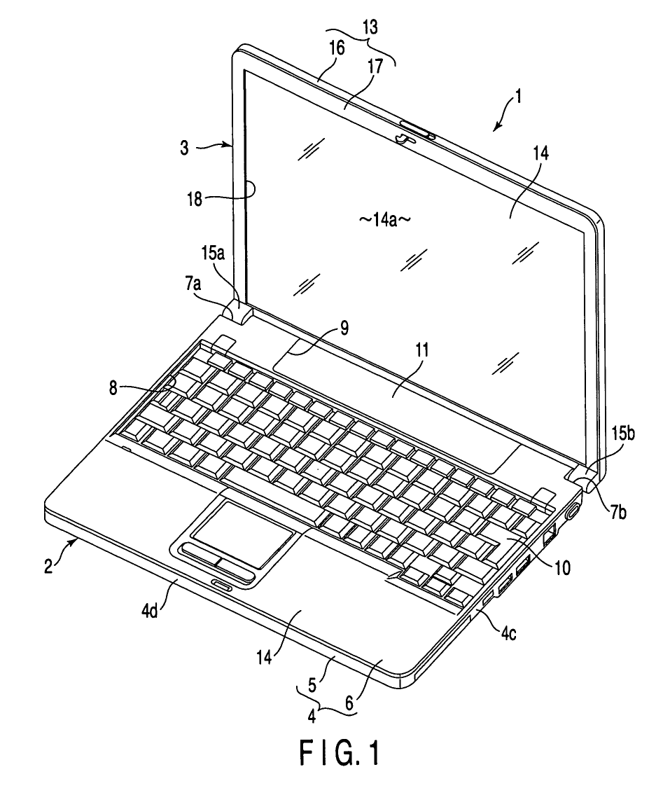

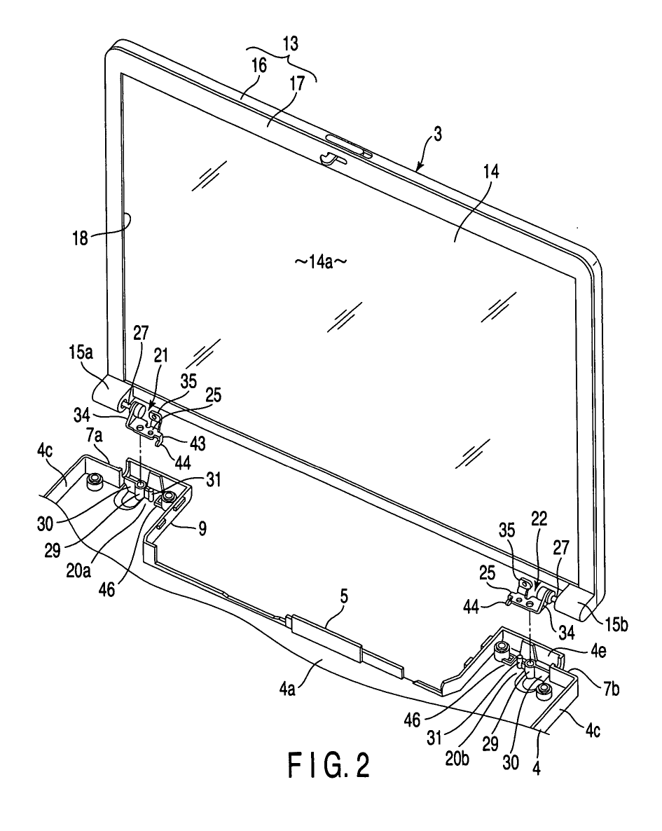

FIGS. 1 and 2 disclose a portable computer 1 which is an example of an electronic apparatus of the present invention. The portable computer 1 comprises a main unit 2 and a display unit 3. The main unit 2 has a flat box-shaped first housing 4. The first housing 4 is formed of a metallic material such as magnesium alloy, and has a bottom wall 4a, a top wall 4b, right and left side walls 4c, a front wall 4d and a rear wall 4e.

The first housing 4 comprises a base 5 and a top cover 6. The base 5 has the bottom wall 4a, the side walls 4c, the front wall 4d and the rear wall 4e. The top cover 6 has the top wall 4b, and covers the base 5 in the state of being detachable from the base 5.

Depressions 7a and 7b are formed in respective corner portions defined by the side walls 6c and the rear wall 4e of the first housing 4. The depressions 7a and 7b are located in the rear end of the first housing 4, and apart from each other in the width direction of the first housing 4.

The first housing 4 has a keyboard mounting portion 8 and a battery receiving portion 9. The keyboard mounting portion 8 is a rectangular recessed portion open to the top surface of the first housing 4, and supports a keyboard 10. The battery receiving portion 9 is located in the rear of the keyboard 10. The battery receiving portion 9 is a rectangular recessed portion open to the bottom wall 4a, the top wall 4b and rear wall 4e of the first housing 4, and supports a detachable battery pack 11.

The display unit 3 has a second housing 13 and a liquid crystal display 14. The second housing 13 has a flat box-shape having almost the same size as that of the first housing 4. The second housing 13 has a pair of leg portions 15a and 15b at one end thereof. The leg portions 15a and 15b are apart from each other in the width direction of the second housing 13, and fitted into the depressions 7a and 7b of the first housing 4, respectively.

The second housing 13 has an LCD cover 16 that supports the liquid crystal display 14, and an LCD mask 17 covering the LCD cover 16. The liquid crystal display 14 has a screen 14a that displays images. The screen 14a is exposed to the outside of the second housing 13 through an opening 18 formed in the LCD mask 17.

As shown in FIG. 2, the base 5 of the first housing 4 has a pair of hinge support portions 20a and 20b. One hinge support portion 20a is located between the left depression 7a and a left end portion of the battery receiving portion 9. The other hinge support portion 20b is located between the right depression 7b and a right end portion of the battery receiving portion 9. The hinge support portions 20a and 20b support the display unit 3, with metallic first and second hinge devices 21 and 22 interposed therebetween, respectively.

The display unit 3 is rotatable between an opened position and a closed position. In the closed position, the display unit 3 lies on the main unit 2 to cover the keyboard 10 from above. In the opened position, the display unit 3 is stood on the rear end portion of the main unit 2 to expose the keyboard 10 and the screen 14a.

The first hinge device 21 extends between the hinge support portion 20a of the base 5 and the left leg portion 15a of the second housing 13. The second hinge device 22 extends between the other hinge portion 20b of the base 5 and the right leg portion 15b of the second housing 13.

The first and second hinge devices 21 and 22 have the same structure, and are fixed to the first and second housings 4 and 13, respectively, in the same manner.

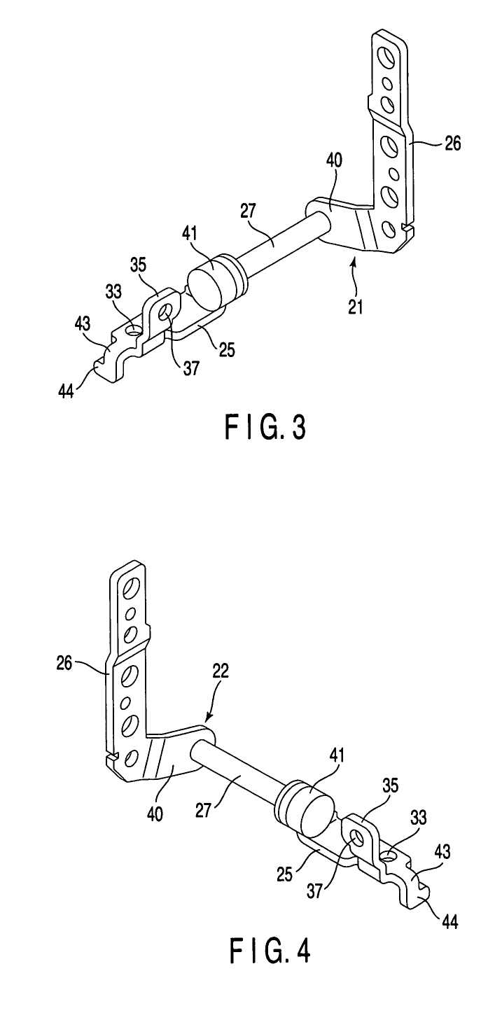

As shown in FIGS. 3 and 4, each of the first and second hinge devices 21 and 22 has a first bracket 25, a second bracket 26 and a hinge shaft 27. The first brackets 25 of the hinge devices 21 and 22 are located on the hinge support portions 20a and 20b of the base 5, respectively.

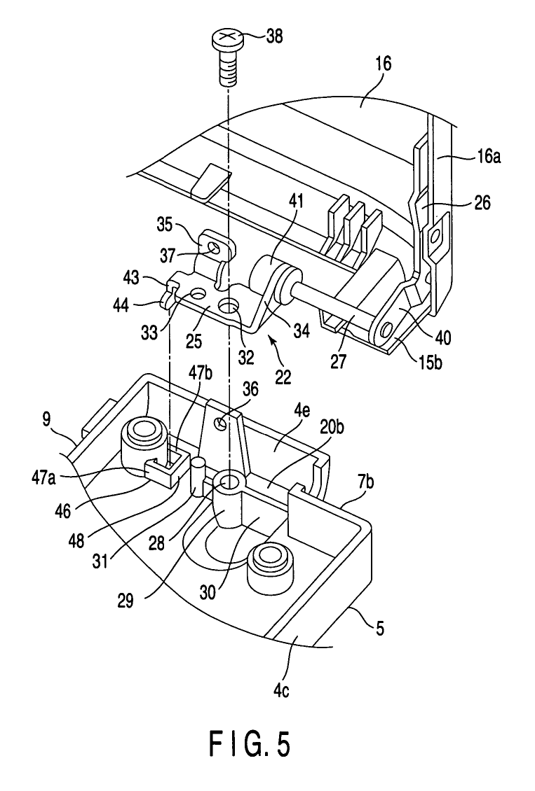

As shown in FIGS. 5 and 9, each of the hinge support portions 20a and 20b has a boss portion 29 having a screw hole 28, a support wall 30 and a positioning pin 31. In each of the hinge support portions 20a and 20b, the boss portion 29, the support wall 30 and the positioning pin 30 project upward from the bottom wall 4a of the base 5, and are arranged in line along the width direction of the base 5. The top end of the boss portion 29 and the top end of the support wall 30 are located on the same plane. The top end of the positioning pin 31 projects higher than the top ends of the boss portion 29 and the support wall 30.

The first bracket 25 has a plate shape having a size enough to be superposed on the top ends of the boss portion 29 and the support wall 30. The first bracket 25 has an insertion hole 32 that conforms to the screw hole 28, and an engagement hole 33 serving as an engaging portion into which the positioning pin 31 is fitted.

Further, the first bracket 25 has a bearing portion 34 and a fixing piece 35. The bearing portion 34 is perpendicularly bent upward from one end of the first bracket 25, and opposed to the depression 7a or 7b inside the base 5. The fixing piece 35 is bent upward from the other end of the first bracket 25, and opposed to the rear wall 4e of the base 5. A screw hole 37 to communicate with an insertion hole 36 opened in the rear wall 4e is formed in a top end portion of the fixing piece 35.

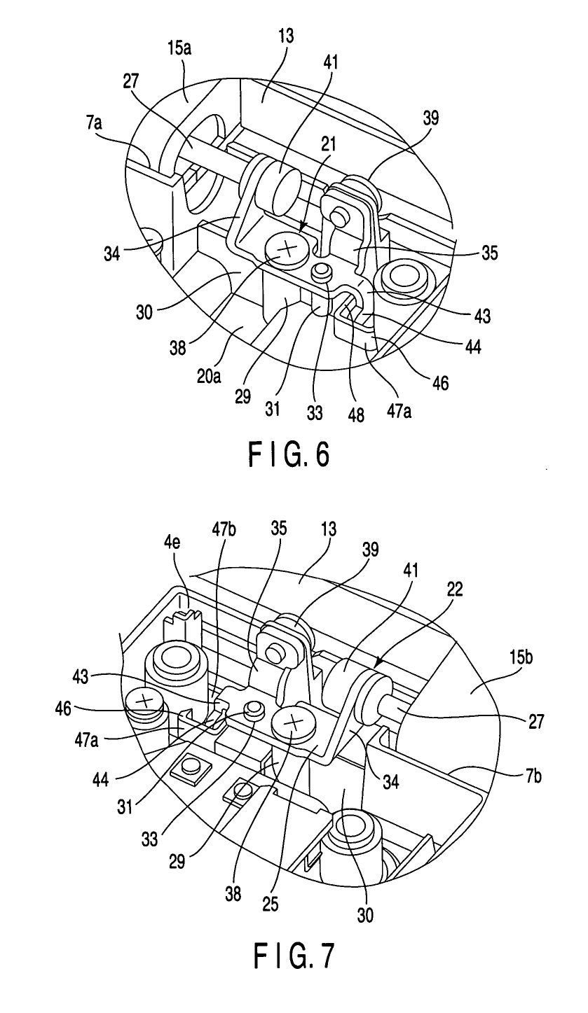

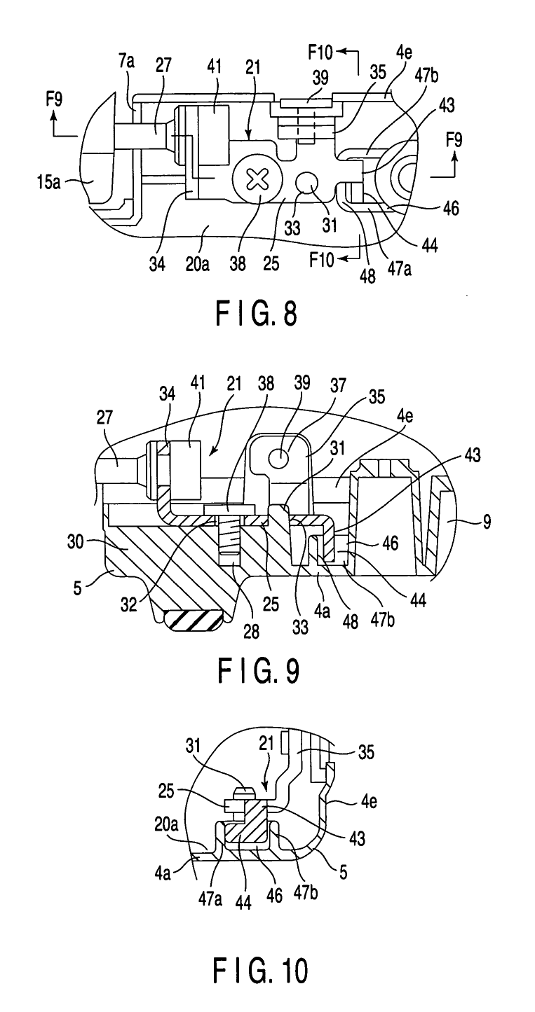

As shown in FIGS. 6 to 8, the first brackets 25 of the first and second hinge devices 21 and 22 are fixed to the hinge support portions 20a and 20b of the base 5, respectively. Each of the first brackets 25 is fixed by two screws 38 and 39. One screw 38 is screwed into the screw hole 28 of the boss portion 29 from above the base 5 through the insertion hole 32. The other screw 39 is screwed into the screw hole 37 from the rear of the base 5 through the insertion hole 36. Therefore, each of the first brackets 25 is supported by both the bottom wall 4a and the rear wall 4e of the base 5.

As typically shown by the second hinge device 22 in FIG. 5, the second bracket 26 is fixed to an internal surface of the side wall 16a of the LCD cover 16 by a screw (not shown). The second bracket 26 has a bearing portion 40 at one end. The bearing portion 40 is located inside the leg portion 15b of the second housing 13.

The hinge shaft 27 extends between the bearing portion 34 of the first bracket 25 and the bearing portion 40 of the second bracket 26, and is horizontally arranged along the width direction of the portable computer 1. One end of the hinge shaft 27 is fixed to the bearing portion 40 of the second bracket 26. The other end of the hinge shaft 27 is connected to the bearing portion 34 of the first bracket 25 to be rotatable around the axis thereof. A brake mechanism 41 that restricts free rotation of the hinge shaft 27 is incorporated into the connecting portion. Therefore, the first bracket 25 and the second bracket 26 are relatively rotatable around the axis of the hinge shaft 27.

In the step of assembling the portable computer 1, the first and the second hinge devices 21 and 22 are attached to the LCD cover 16. Therefore, the first and second hinge devices 21 and 22 and the display unit 3 are unitized as one assembly. Therefore, as shown in FIG. 2, the hinge shafts 27 of the first and second hinge devices 21 and 22 project from the leg portions 15a and 15b, respectively, to the outside of the second housing 13, and the first brackets 25 of the hinge devices 21 and 22 are located between the leg portions 15a and 15b.

The first brackets 25 of the first and second hinge devices 21 and 22 accompanied with the display unit 3 are fitted to the hinge support portions 20a and 20b of the base 5, respectively. Specifically, the first brackets 25 are guided into the hinge support portions 20a and 20b with the display unit 3 stood, and fixed to the hinge support portions 20a and 20b by screws 38 and 39.

Each of the first brackets 25 has a fitting portion 43 at the other end thereof opposite to that having the bearing portion 34. The fitting portion 43 is perpendicularly bent downward from the other end of the first bracket 25, and has a hook portion 44 at its bottom end. The hook portion 44 has a size larger than that of the fitting portion 43 in the depth direction of the base 5.

Each of the hinge support portions 20a and 20b of the base 5 has a holding portion 46 in a position corresponding to the other end of the first bracket 25. The holding portion 46 has first and second wall portions 47a and 47b. The first and second wall portions 47a and 47b project upward from the bottom wall 4a of the base 5, and are opposed to each other in the depth direction of the base 5. Therefore, the first and second wall portions 47a and 47b are arranged in a line along the direction perpendicular to the axis of the hinge shaft 27.

In the state where the first bracket 25 is superposed on the top ends of the boss portion 29 and the support wall 30, the hook portion 44 located at the other end of the first bracket 25 is fitted between the first and second wall portions 47a and 47b. In other words, the first and second wall portions 47a and 47b hold the hook portion 44 therebetween from the front and the rear of the base 5. Thereby, the first bracket 25 is held by the hinge support portions 20a and 20b, in the state where movement of the base 5 in the depth direction is restrained.

Further, the first and second wall portions 47a and 47b are connected to each other, with a third wall portion 48 interposed therebetween. The third wall portion 48 projects upward from the bottom wall 4a of the base 5, and extends between ends of the first and second wall portions 47a and 47b. The third wall portion 48 secures sufficient strength of the first and second wall portions 47a and 47b.

The following is explanation of a procedure of connecting the display unit 3 to the main unit 2, in the portable computer 1 having the above structure.

As shown in FIG. 2, first, the display unit 3 is maintained in a stood position with respect to the first brackets 25 of the first and second hinge devices 21 and 22. In this state, the first brackets 25 are guided into the hinge support portions 20a and 20b in the rear end portion of the base 5.

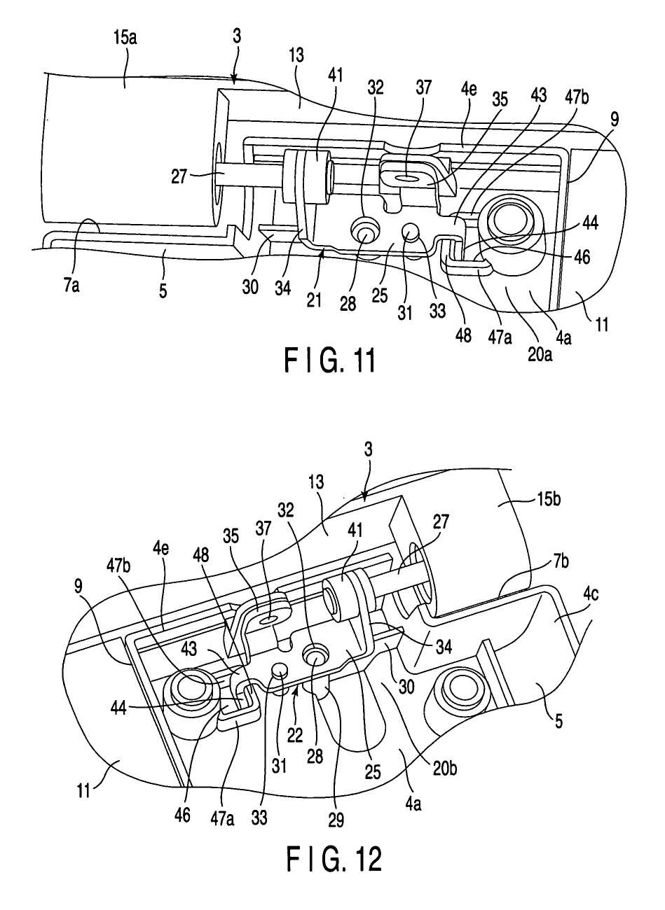

In this step, as shown in FIGS. 11 and 12, the positioning pins 31 projecting from the bottom wall 4a of the base 5 are inserted into the engagement holes 33 of the first brackets 25. Further, the hook portions 44 of the first brackets 25 are fitted between the respective first and second wall portions 47a and 47b projecting from the bottom wall 4a.

Inserting the positioning pins 31 into the engagement holes 33 fixes the positions of the first brackets 25 and the boss portions 29. This restrains movement of the first brackets 25 in the axial direction of the hinge shafts 27 and the depth direction of the first housing 4, and the insertion holes 32 of the first brackets 25 match the screw holes 28 of the respective boss portions 29.

Further, as shown in FIGS. 10 to 12, the hook portions 44 of the first brackets 25 are engaged with the respective first and second wall portions 47a and 47b. The first and second wall portions 47a and 47b hold the respective hook portions 44 of the first brackets 25 from the front and the rear of the first housing 4. Thereby, the first brackets 25 are held by the hinge support portions 20a and 20b, and the display unit 3 is prevented from falling down to the front or the rear of the base 5.

Therefore, the first brackets 25 of the first and second hinge devices 21 and 22 are temporarily fixed to the hinge support portions 20a and 20b of the base 5, in the state where the display unit 3 is stood.

Next, the screws 38 and 39 are screwed into the screw holes 28 and 37 through the insertion holes 32 and 36. This screwing fixes the first brackets 25 of the first and second hinge devices 21 and 22 to the hinge support portions 20a and 20b of the base 5, respectively, and completes connection of the main unit 2 and the display unit 3.

According to the embodiment of the present invention having the above structure, the hinge support portions 20a and 20b of the first housing 4 have the respective first and second wall portions 47a and 47b which hold the first brackets 25 of the first and second hinge devices 21 and 22 therebetween, respectively.

Therefore, until the first brackets 25 of the first and second hinge devices 21 and 22 are fixed to the hinge portions 20a and 20b by the screws 38 and 39, the first brackets 25 are temporarily fixed to the hinge support portions 20a and 20b, to prevent the display unit 3 from falling down to the front or the rear of the main unit 2.

This unnecessitates supporting the display unit 3 with the operator's hand while the first brackets 25 are fixed to the hinge support portions 20a and 20b by the screws 38 and 39. Therefore, it is possible to easily perform assembly operation of the portable computer 1.

Further, according to the above structure, the base 5 on which the first brackets 25 are fixed is formed of metal having stiffness higher than that of synthetic resin. Therefore, the base 5 can sufficiently withstand the force applied from the first brackets 25 when the display unit 3 is rotated. Thus, it has the advantage that it is possible to reduce the size and weight of the connecting portions between the base 5 and the first brackets 25, and contribute to compactification of the first brackets 25.

Although each of the fitting portions of the first brackets are inserted between the first and second wall portions which are stood on the bottom wall of the base in the above embodiment, the present invention is not limited to it. For example, concave portions each having supporting surfaces facing each other are formed in the bottom wall of the base, and the fitting portions of the first brackets are inserted between the supporting surfaces of the respective concave portions.

Further, the electronic apparatus of the present invention is not limited to portable computers. For example, the present invention can be carried out in the same manner in DVD players having an openable liquid crystal monitor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus comprising:
a first housing;
a second housing separate from the first housing; and
a hinge device which rotatably connects the first housing with the second housing, the hinge device including a first bracket to be fixed to the first housing, a second bracket to be fixed to the second housing, and a hinge shaft which connects the first bracket and the second bracket such that the first and second brackets are relatively rotatable,
wherein the first housing has a holding portion in a position corresponding to the first bracket, and the holding portion catches the first bracket and thereby holds the hinge device accompanied with the second housing on the first housing.

2. The electronic apparatus according to claim 1, wherein the holding portion of the first housing has a first and a second wall portions which are opposed to each other in a direction perpendicular to the hinge shaft, and the first bracket has a fitting portion which is inserted between the first and second wall portions and engaged with the wall portions.

3. The electronic apparatus according to claim 2, wherein the first and second wall portions are connected with each other with a third wall portion interposed therebetween.

4. The electronic apparatus according to claim 1, wherein the first bracket has an engagement portion which performs positioning of the hinge shaft in an axial direction thereof with respect to the first housing.

5. The electronic apparatus according to claim 1, wherein the first bracket is fixed to the first housing by screws, in a state of being held by the holding portion.

6. An electronic apparatus comprising:
a first housing;
a second housing separate from the first housing; and
a hinge device which rotatably connects the first housing with the second housing, the hinge device including a first bracket to be fixed to the first housing, a second bracket to be fixed to the second housing, and a hinge shaft which connects the first bracket and the second bracket such that the first and second brackets are relatively rotatable and extends in a width direction of the first and second housings,
wherein the first housing has a holding portion in a position corresponding to the first bracket, the first bracket has a fitting portion to be fitted into the holding portion, and the hinge device accompanied with the second housing is held on the first housing by a fit between the holding portion and the fitting portion, in a state where the hinge device is restrained from moving in a direction perpendicular to the hinge shaft.

7. The electronic apparatus according to claim 6, wherein the holding portion has a first and a second wall portions which hold the fitting portion therebetween from the direction perpendicular to the hinge shaft.

8. A hinge device comprising:
a first bracket to be fixed to a first housing;
a second bracket to be fixed to a second housing; and
a hinge shaft which extends between the first bracket and the second bracket, the hinge shaft connecting the first housing with the second housing by the first and second brackets such that the first and second housings are relatively rotatable,
wherein the first bracket has a fitting portion which is engaged with the first housing, and the fitting portion holds a unit including the hinge shaft, the second bracket and the second housing on the first housing.

9. The hinge device according to claim 8, wherein the fitting portion restrains the first bracket from moving in a direction perpendicular to the hinge shaft.

10. The hinge device according to claim 8, wherein the first bracket has an engagement portion which performs positioning of the hinge shaft in an axial direction thereof with respect to the first housing.

11. The hinge device according to claim 8, wherein the first bracket is fixed to the first housing by screws, in a state where the fitting portion is engaged with the first housing.
